(19) United States
(12) Patent Application Publication
(10) Pub. No.: US 2026/0081357 A1
(43) Pub. Date: Mar. 19, 2026

(54) SYSTEMS AND METHODS FOR MULTI-BAND CONCENTRIC HELICAL ANTENNAS

(71) Applicant: MacDonald, Dettwiler and Associates Corporation, Sainte-Anne-de-Bellevue (CA)

(72) Inventors: Benoit COLSON, Sainte-Anne-de-Bellevue (CA); Karim GLÂTRE, Montreal (CA)

(21) Appl. No.: 19/319,034

(22) Filed: Sep. 4, 2025

Related U.S. Application Data
(60) Provisional application No. 63/695,618, filed on Sep. 17, 2024.

(51) Int. Cl. H01Q 11/08; H01Q 21/06

(52) U.S. Cl. CPC H01Q 11/08; H01Q 21/061

(57) ABSTRACT

Provided herein are systems and methods for multi-band helical antennas. The multi-band concentric helical antenna system includes a base, a first helical antenna and at least a second helical antenna, wherein the second helical antenna is within the first helical antenna, wherein the first helical antenna has a first frequency band and the second helical antenna has a second frequency band which is not the same as the first frequency band, and wherein the first helical antenna and the second helical antenna are connected to the base and positioned within an aperture of the base. The multi-band helical antenna system may further include N additional antennas, and may be used as a single radiating element or in an array of radiating elements.

### TECHNICAL FIELD

The following relates generally to antennas, and more specifically to systems and methods of combining helix antennas within the same aperture.

### INTRODUCTION

In the space industry, antennas are common components on a spacecraft and are used for communication over a distance. Different antenna may have different frequency bands depending on the role of the antenna. However, there may be a limited available volume on a spacecraft platform to accommodate all of the necessary antennas.

Accordingly, there is a need for systems and methods which allow more antennas to be present on a spacecraft while minimizing the platform volume used for antennas.

### SUMMARY

Provided herein is a multi-band concentric helical antenna system comprising a base, a first helical antenna and at least a second helical antenna, wherein the second helical antenna is within the first helical antenna, wherein the first helical antenna has a first frequency band and the second helical antenna has a second frequency band which is not the same as the first frequency band, and wherein the first helical antenna and the second helical antenna are connected to the base and positioned within an aperture of the base.

The antenna system may be on a spacecraft.

The first helical antenna and second helical antenna may be used for navigation.

The first helical antenna and second helical antenna may be radiating elements which together form a multi-band radiating element.

The base may include a first cup within which the first helical antenna is positioned, wherein the first cup comprises a first wall.

The base may include a second cup within which the second helical antenna is positioned wherein the second cup comprises a second wall.

The first or second cup may include a choke, wherein an outer wall encloses the first wall.

The first helical antenna and the second helical antenna may be concentric.

The antenna system may further comprise N additional antennas, wherein each of the N additional antennas, is connected to the base and positioned within the aperture of the base, and wherein each of the N additional antennas has a distinct frequency band.

The first helical antenna and the second helical antenna may have the same helical handedness.

The first helical antenna and the second helical antenna may have the opposite helical handedness.

At least one of the first helical antenna and the second helical antenna may be tapered.

Provided herein is a multi-band radiating element comprising a first helical antenna and at least a second helical antenna, wherein the second helical antenna is positioned within the first helical antenna, wherein the first helical antenna has a first frequency band and the second helical antenna has a second frequency band which is not the same as the first frequency band, and wherein the first helical antenna and the second helical antenna are connected to a base. Provided herein is an antenna array comprising a plurality of said radiating elements. The array may comprise at least one single frequency radiating element.

Provided herein is a method of constructing a multi-band helical antenna system comprising connecting a first helical antenna having a first frequency band to a base having an aperture, wherein the aperture is an area of the base under the antenna, and connecting a second helical antenna having a second frequency band different from the first frequency band to the base, wherein the second antenna is within the aperture of the base, and the first antenna is within the second antenna.

The method may further include connecting N additional antennas, wherein each of the N additional antennas, is positioned within the aperture of the base, and wherein each of the N additional antennas has a distinct frequency band.

The multi-band helical system may further include a first cup comprising an enclosed wall which is roughly perpendicular to the base and roughly parallel to the direction of emitted or received signals, and the method may further include wherein the first helical antenna is positioned within an aperture of the first cup.

The multi-band helical system may further include a second cup comprising an enclosed wall which is roughly perpendicular to the base and roughly parallel to the direction of emitted or received signals, and the method may further include wherein the second helical antenna is positioned within an aperture of the second cup.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1A is a side perspective view of a multi-band helical antenna system including a first antenna and a second antenna attached concentrically to the same base, according to an embodiment;

FIG. 1B is an elevated perspective view of the multi-band helical antenna system of FIG. 1A, according to an embodiment;

FIG. 2 is a photograph of a cup and choke for use with a helical antenna, according to an embodiment; and

FIG. 3 is a flow diagram of a method of constructing a multi-band antenna system, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Further, although process steps, method steps, algorithms or the like may be described (in the disclosure and/or in the claims) in a sequential order, such processes, methods, and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to antennas and more specifically to systems and methods of combining multiple helix antennas within the same aperture.

As described above antennas are near-universal elements on spacecraft, such as satellites. However, the platforms used for satellites are becoming smaller, reducing the area of the satellite on which an antenna can be mounted. Therefore, reducing the size of antennas is increasingly desired or required.

The multi-band antenna system of the present disclosure reduces the area of the spacecraft platform used by antennas by positioning at least two differently sized helical antennas concentrically within a single aperture, with each antenna working within a different frequency band.

Because the diameter of the helix of the antenna determines the frequency, combining at least two helical antennas of different sizes and frequency bands within the same aperture allows for the size of the antennas to be smaller than one antenna covering a larger frequency band.

Helix antennas are often used for GPS/navigation functions on a spacecraft, but may also be used as radiating elements.

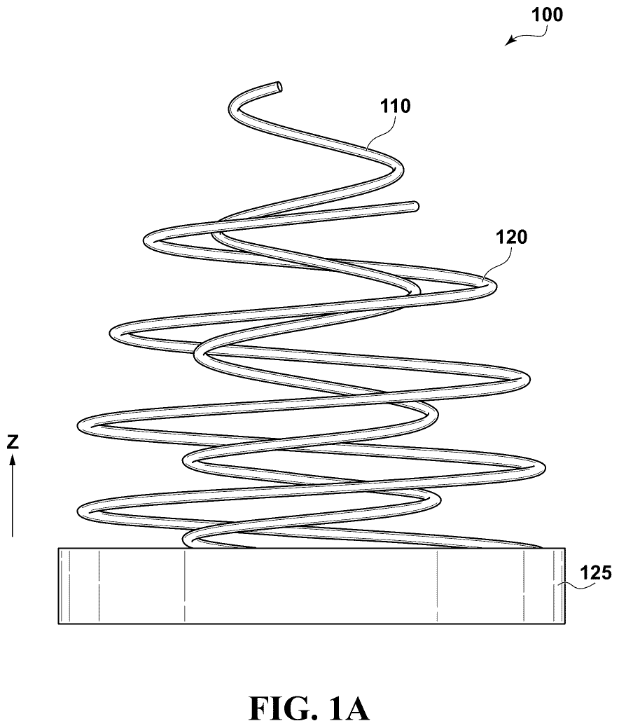

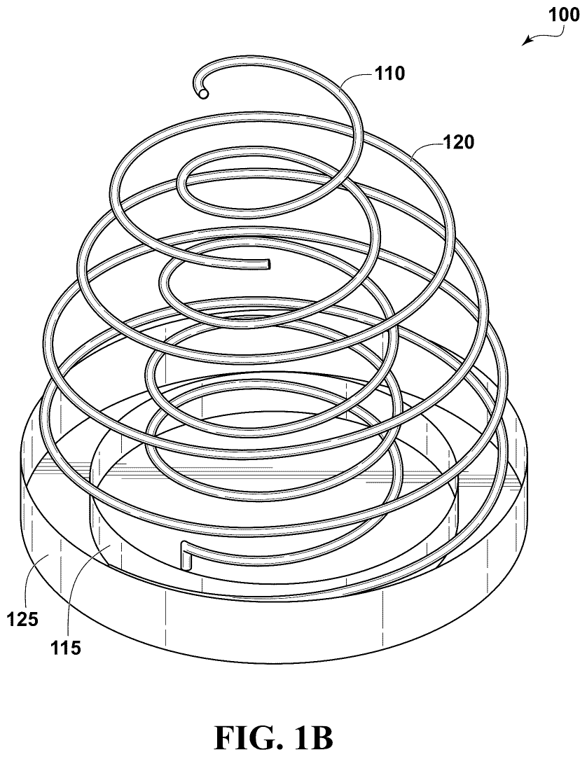

Referring now to FIGS. 1A and 1B, shown therein is a multi-band helical antenna system 100, according to an embodiment. System 100 includes a first antenna 110 and a second antenna 120 attached concentrically to the same base or ground plane. Each pair of first antenna and second antenna may be used as a single radiating element or may be employed in an array of radiating elements (i.e., multiple instances of multi-band concentric helical antenna corresponding to array elements in the array). The system 100 may be used in a phased array antenna. While an array of elements are present on a single spacecraft, each instance of a radiating element may be attached to the same base or ground plane, or each instance (or subsets) of radiating elements may be attached to different bases or ground planes.

The multi-band helical antenna system 100 includes the first antenna 110, the second antenna 120, a first antenna cup 115, and a second antenna cup 125. The cups 115, 125 may be the same or different heights. The antenna system 100 may also be referred to as a dual-band helical antenna system since two frequency bands are covered by the system 100: a first frequency band by the first antenna 110 and a second frequency band by the second antenna 120.

In other embodiments, the system 100 may include more than two antennas. Each additional antenna may have a respective cup. Each additional antenna has a different frequency band. In other words, each antenna in the system 100 covers a different frequency band. Thus, a greater number of antennas in system 100 may thus cause antenna system 100 to cover a larger overall frequency band.

The first antenna 110 is a tapered helical antenna wherein a diameter of the helix decreases in the Z direction.

The second antenna 120 is a tapered helical antenna wherein a diameter of the helix decreases in the Z direction.

Tapering of the helix increases the frequency bandwidth of an antenna. Therefore, using tapered helices increases the frequency bandwidth of the antenna system 100. In other embodiments, one or both of the first or second antennas may not be tapered.

The first antenna 110 is positioned within the second antenna 120. The helices of first antenna 110 and second antenna 120 are concentric. In other embodiments, the antennas may be slightly off-centre from concentric; however, performance of the antenna system will decrease as the distance away from concentricity increases.

In an embodiment of the antenna system 100 with more than two helical antennas, each additional antenna is positioned within the other antennas such that all of the helical antennas are concentric (or very near concentric).

The first antenna 110 and the second antenna 120 are located within the same aperture. The aperture is the larger area at the “bottom” of the antennas 110, 120 (i.e., at the widest part of the antennas).

Within the aperture is a cup 115, and at the outside of the aperture is a cup 125. Cup 115 is associated with the first antenna and cup 125 is associated with the second antenna. Cups 115 and 125 enable decoupling of the two antennas 110, 120. Decoupling improves helix return loss and reduces the background radiation of the antenna system 100. In other embodiments, the antenna system 100 may not include any cups.

The bottoms of first antenna 110 and second antenna 120 (i.e., the vertical parts of the antenna which are at the “bottom” of the antenna) may be at any relative locations. For example, the positioning may be close as in FIGS. 1A and 1B or may be at opposite sides of the antenna system 100. Opposite positioning of the connections may optimize decoupling of the antennas.

The helices of the first antenna 110 and the second antenna 120 are wound in the same direction (i.e., have the same handedness). In other embodiments, the helices may be wound in different directions. Helices with opposite handedness may support opposite polarization, which is not possible with a single helix antenna.

In some embodiments, the system 100 may include helix supports for the helices. The supports may include support threads and a central support attached to the base. The support threads are connected to the helices and to the central support attached to the base. The helix supports restrict movement of the helices away from a nominal position.

In various embodiments, the helix shape, cup dimensions, and the input positions of the helices may be optimized based on the specific frequencies of the helical antennas to increase performance.

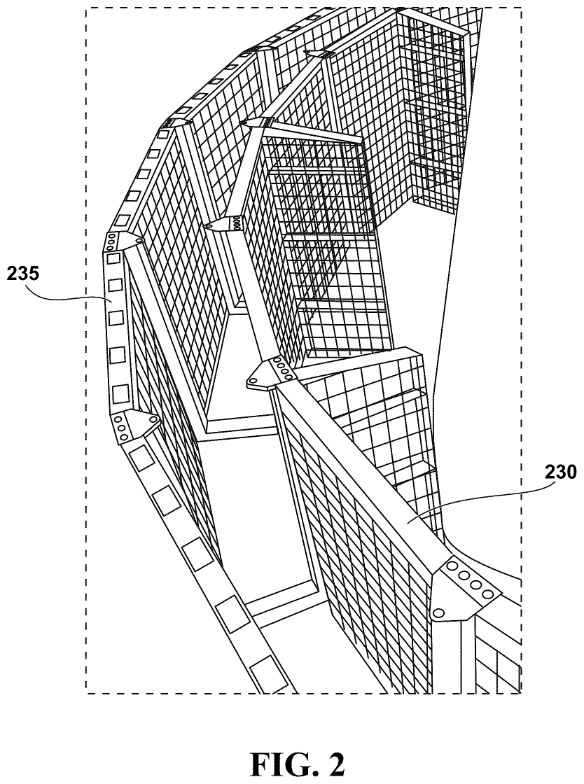

Referring now to FIG. 2, shown therein is a photograph of a cup 230 with a choke 235 for use with a helical antenna, according to an embodiment.

FIGS. 1A and 1B illustrate an antenna system 100 with a base comprising two cups 115, 125, with one cup associated with the first antenna 110 and one cup associated with the second antenna 120. FIG. 2 is a photograph of a cup 230 comprising a near-circular, closed wall (only a portion of the cup is shown), and a second wall 235 around the cup 230. The second wall prevents current from flowing outside of the choke. In an embodiment of antenna system 100, a helical antenna is located within the aperture of the cup 230. In a dual-band helical antenna system or a multi-band (more than two) helical antenna system, such as system 100, there would be another cup inside of cup 230, which may or may not include a second choke. That is, the cup 230 and choke 235 shown in FIG. 2 provide an example of a cup which could be used with a helical antenna but are not a configuration which would be used with a dual-band helical antenna system as described herein. The two cups shown in FIGS. 1A and 1B represent a cup system to be used with a dual-band antenna system.

The cup 230 and choke 235 of FIG. 2 are not solid and have a plurality (i.e., many) openings. The cup 230 and choke 235 may thus be considered to be weight-relieved (with the openings providing the weight relief). The openings enable the cup 230 and choke 235 to have a smaller weight than if the cup 230 and choke 235 were solid. Reducing the weight by including holes in the cup/choke may be particularly beneficial for larger antennas, where mass reduction is critical. Generally, the weight relief holes are small enough that certain wavelengths cannot pass through.

The cup 230 and choke 235 of FIG. 2 also are not perfectly circular with panels which meet at angles. In various cup (and possibly choke) embodiments for a multi-band antenna system such as system 100, the shape of the cup 230 (and possibly choke 235) may be circular, hexagonal, etc. The inner and outer walls may have the same or different shapes.

In other embodiments, the cup/choke system may comprise three walls with a W shape.

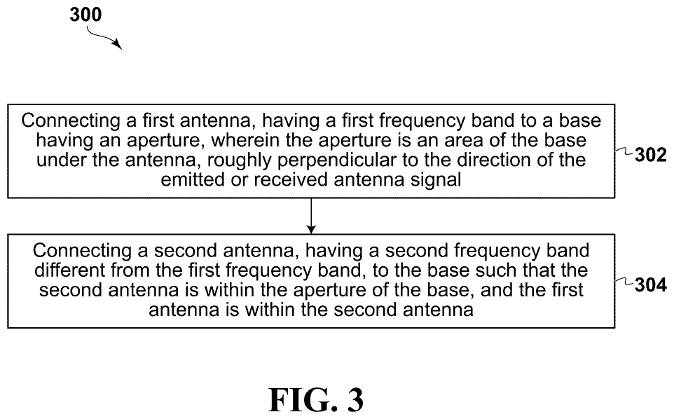

Referring now to FIG. 3, shown therein is a method 300 of constructing a multi-band antenna system, according to an embodiment. The multi-band antenna system includes two helical antennas. The method 300 may be used to construct the system 100 of FIGS. 1A-1B.

At 302, a first antenna having a first frequency band is connected to a base having an aperture, wherein the aperture is an area of the base under the antenna, roughly perpendicular to the direction of the emitted or received antenna signal.

At 304, a second antenna having a second frequency band different from the first frequency band is connected to the base such that the second antenna is within the aperture of the base, and the first antenna is within the second antenna.

The first antenna has a higher frequency band than the second antenna due to the physical requirement that the diameter of the first antenna be smaller than the diameter of the second antenna.

The first antenna and the second antenna are preferably concentric.

The first antenna and second antenna may have the same or opposite helical handedness.

Either or both of the first antenna and the second antenna may be tapered.

In some embodiments, the first antenna is within an aperture of a first cup comprising an enclosed wall which is roughly perpendicular to the base and roughly parallel to the direction of emitted or received signals. The second antenna is within an aperture of a second cup comprising an enclosed wall which is, again, roughly perpendicular to the base and roughly parallel to the direction of the emitted or received signals. In other embodiments, only one of the first antenna and second antenna may be associated with a cup.

In other embodiments, a cup may further include an outer enclosed wall to enable the cup to act as a choke.

In other embodiments, the method 300 further includes adding N additional helical antennas to the antenna system, wherein each helical antenna is connected to the base and each helical antenna has a distinct frequency band.

While the above description provides examples of one or more apparatus, methods, or systems, it will be appreciated that other apparatus, methods, or systems may be within the scope of the claims as interpreted by one of skill in the art.

1. A multi-band concentric helical antenna system, the system comprising:
a base;
a first helical antenna and at least a second helical antenna, wherein the second helical antenna is within the first helical antenna, wherein the first helical antenna has a first frequency band and the second helical antenna has a second frequency band which is not the same as the first frequency band, and wherein the first helical antenna and the second helical antenna are connected to the base and positioned within an aperture of the base.

2. The antenna system of claim 1, wherein the antenna system is on a spacecraft.

3. The antenna system of claim 2, wherein the first helical antenna and second helical antenna are used for navigation.

4. The antenna system of claim 1, wherein the first helical antenna and second helical antenna are radiating elements, and together form a multi-band radiating element.

5. The antenna system of claim 1, wherein the base includes a first cup within which the first helical antenna is positioned, wherein the first cup comprises a first wall.

6. The antenna system of claim 1, wherein the base includes a second cup within which the second helical antenna is positioned, wherein the second cup comprises a second wall.

7. The antenna system of claim 5, wherein the cup includes a choke, wherein an outer wall encloses the first wall.

8. The antenna system of claim 1, wherein the first helical antenna and the second helical antenna are concentric.

9. The antenna system of claim 1, further comprising N additional antennas, wherein each of the N additional antennas, is connected to the base and positioned within the aperture of the base, and wherein each of the N additional antennas has a distinct frequency band.

10. The antenna system of claim 1, wherein the first helical antenna and the second helical antenna have the same helical handedness.

11. The antenna system of claim 1, wherein the first helical antenna and the second helical antenna have the opposite helical handedness.

12. The antenna system of claim 1, wherein at least one of the first helical antenna and the second helical antenna is tapered.

13. A multi-band radiating element comprising:
a first helical antenna and at least a second helical antenna, wherein the second helical antenna is positioned within the first helical antenna, wherein the first helical antenna has a first frequency band and the second helical antenna has a second frequency band which is not the same as the first frequency band, and wherein the first helical antenna and the second helical antenna are connected to a base.

14. An antenna array comprising a plurality of the radiating elements of claim 13.

15. The array of claim 14 further comprising at least one single frequency radiating element.

16. A method of constructing a multi-band helical antenna system, the method comprising:
connecting a first helical antenna having a first frequency band to a base having an aperture, wherein the aperture is an area of the base under the antenna; and
connecting a second helical antenna having a second frequency band different from the first frequency band to the base, wherein the second antenna is within the aperture of the base, and the first antenna is within the second antenna.

17. The method of claim 16 wherein the multi-band helical system further includes N additional antennas, wherein each of the N additional antennas, is positioned within the aperture of the base, and wherein each of the N additional antennas has a distinct frequency band.

18. The method of claim 16 wherein the multi-band helical system further includes a first cup comprising an enclosed wall which is roughly perpendicular to the base and roughly parallel to the direction of emitted or received signals, wherein the first helical antenna is within an aperture of the first cup.

19. The method of claim 18 wherein the multi-band helical system further includes a second cup comprising an enclosed wall which is roughly perpendicular to the base and roughly parallel to the direction of emitted or received signals, wherein the second helical antenna is within an aperture of the second cup.
